(19) United States
(12) Patent Application Publication
(10) Pub. No.: US 2019/0333061 A1
(43) Pub. Date: Oct. 31, 2019

(54) Apparatus and Method for Updating ATMs and Providing GUI Content for Selecting, Purchasing, and Transmitting Electronic Stored Value Instruments

(71) Applicants: Jerry Jackson, Fort Worth, TX (US); William Ward, Fort Worth, TX (US)

(72) Inventors: Jerry Jackson, Fort Worth, TX (US); William Ward, Fort Worth, TX (US)

(21) Appl. No.: 15/964,858

(22) Filed: Apr. 27, 2018

(51) Int. Cl. G06Q 20/40; G06Q 20/10; G06F 3/0482; G06F 3/0488

(52) U.S. Cl. CPC G06Q 20/401; G06F 3/0488; G06F 3/0482; G06Q 20/1085

(57) ABSTRACT

In an automated teller machine (ATM) deploying a functionality for the purchase and transmission of electronic gift cards, pre-paid stored-value instruments, and/or cellular phone minutes, account recharging, or data recharging via the ATM graphical user interface (GUI). Additionally, the ATM having a functionality for the receipt, viewing, and redemption of gift cards, pre-paid stored-value instruments, and/or cellular phone minutes or data via short messaging service (SMS or other messaging service) delivery to a user device after being purchased and transmitted via the ATM GUI. Further, the pre-existing ATM being enabled to be remotely updated graded to augment enable the above-stated functionality in addition to its pre-existing ATM functionality. Further, the pre-existing ATM being enabled for remotely updating the ATM GUI.

### FIELD OF THE INVENTION

The exemplary and non-limiting embodiments of this invention relate generally to automated teller machine systems, methods, devices, and computer programs, and more specifically, relate to systems and processes using automated teller machines implementing a graphic user interface enabling a user to purchase and transmit electronic stored-value instruments via an ATM.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

The following abbreviations that may be found in the specification and/or the drawing figures are defined as follows:

ATM automated teller machine

API application program interface

GPR general purpose reloadable

GUI graphic user interface

PIN personal identification number

SMS short message service

MMS multimedia messaging service

URL uniform resource locator

Common types of financial instruments include credit cards, debit cards, and stored-value instruments. A stored-value instrument is a financial instrument, usually structured as a means for payment, in which funds are associated with the instrument and not necessarily associated with any individual. Gift cards, pre-paid cards, and pre-paid cellular phone minutes or data plans cards are a common form of stored-value instrument. The following discussion related to “gift cards” is equally applicable to other forms of store-value instruments for purposes of this application. Gift cards in particular have become extremely popular in recent years. Gift cards essentially relieve the donor of the burden of selecting a specific and individually appropriate gift for the recipient, instead allowing the recipient to choose, from the range of products sold by the issuer, the actual goods or services he or she wishes upon redemption. Most gift cards resemble credit cards in size and composition, although increasingly gift cards are becoming virtualized for delivery and redemption across digital networks. Gift cards also tend to display a specific theme that corresponds to the issuer of the card. Although gift cards are typically identified by a specific number or code, gift cards are typically not associated with an individual name or account. Thus, gifts cards can be used by anybody. In order to support gift cards, an issuer of gift cards maintains (directly or indirectly) an on-line electronic system for authorization and accounting of gift cards issued by the issuer. Some gift cards can be “reloaded” with additional monetary value. Thus, the funds associated with such gift cards can be depleted and replenished multiple times.

A closed-loop stored-value instrument (or simply “closed-loop instrument”) is typically sold by an individual retailer, serviced by the retailer (or its agents), and is accepted for purchases only at that particular retailer's locations or websites. Another characteristic of a closed-loop instrument is that such an instrument is issued by an entity and liability is incurred by the same entity. For example, a merchant (such as Company X) issues a gift card with a positive balance and, upon issuance, incurs liability to offer goods or services in exchange for the monetary value reflected by the balance on the gift card. The gift card may only be used to purchase goods or services from that particular merchant.

An “open-loop” stored-value instrument is an instrument that is issued by a bank or other financial institution that has a banking license. A banking license requires its holder to comply with general banking regulations to which issuers of closed-loop instruments need not comply. Open-loop instruments, unlike closed-loop instruments, also may operate over debit or credit networks, carry a network logo (e.g., Visa®), and can be used at any retail location that accepts the payment form. Common open-loop instruments include debit cards that are issued by banks and credit cards that are issued by Visa®, MasterCard®, American Express® or Discover®. When a customer with an open-loop instrument completes a purchase from a merchant using the open-loop instrument, the customer incurs liability to pay the issuing bank while the issuer of the open-loop instrument authorizes and settles against the liability.

Some stored-value instruments may be considered “semi-open” in that they may be accepted by a limited number of different merchants. An example of such an instrument is a “mall card” that is accepted by multiple (or all) merchants in a particular mall. Another example of such an instrument is a “university card” that is accepted by multiple (or all) merchants located on or around a particular university's campus. These “semi-open” instruments are considered closed-loop because the issuer is not a financial institution that is required to have a banking license and the merchants that accept the instruments are limited to those designated by the issuer of the instrument.

It should be appreciated that the various embodiments of the present invention described in more detail herein can interchangeably use one or more of the above-described closed-loop, open-loop, or semi-open stored-value instruments.

The present invention relates to ATMs capable of handling currencies and interacting with bank and credit cards to withdraw funds from a cardholder's account. The ATMs allow a bank card cardholder to check their bank account balances and withdraw, transfer, or deposit funds in the typical manner of transaction known in the art.

The present invention enables a process for remote or local updating of the ATMs. The present invention enables a process for dynamic updating of the ATM GUI to allow up-to-date services and products to be depicted and offered to the ATM user or a bystander that would potentially use the ATM. The present invention also enables the purchasing and transmission of electronic stored-value instruments, such as gift cards (or other closed-loop instruments) or open-loop instruments, or direct transfer of value (e.g. donations), via the upgraded ATM GUI. The present invention also enables the viewing and redemption of the aforementioned stored-value instruments via SMS, MMS, or electronic mail on the recipient's device.

### SUMMARY OF THE INVENTION

The present invention provides apparatuses, methods, and systems for updating ATMs to enable and provide users with value-added services such as the selection, purchasing, and transmission of electronic stored-value instruments to a recipient via SMS and/or other messaging service.

These objectives are illustrative in nature. Additional advantages and applications for the present invention will be readily apparent to persons skilled in the art upon a review of the invention and the disclosures contained herein.

### BRIEF DESCRIPTION OF THE DRAWINGS

The drawings referenced below are included so that the features and advantages of the presently disclosed invention may be better understood. It should be noted, however, that the attached drawings are meant only to be illustrative of particular embodiments of the invention and should not be considered limiting of its scope. The invention itself, as well as a preferred mode of use, further objectives and advantages thereof, will best be understood by reference to the following detailed description of the preferred embodiment when read in conjunction with the attached drawings, which are summarized below:

FIG. 1 depicts a representative ATM interface and visual display screen.

FIG. 2 depicts a representative ATM interface and visual display screen showing depictions of various categories of stored-value instruments.

FIG. 3 depicts a representative ATM interface and visual display screen showing depictions of denominations of the offered stored-value instruments within a selected category.

FIG. 4 depicts a representative ATM interface and visual display screen showing a depiction of a telephone prompt.

FIG. 5 depicts a process for interacting with a received electronic stored-value instrument.

FIG. 6 depicts a process for using a representative ATM to purchase an electronic stored-value instrument.

### DETAILED DESCRIPTION OF THE INVENTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Several techniques are described herein for extending the capabilities of ATMs to provide additional value-added services or to create additional revenue streams for the owners and operators of the ATMs. Although many examples that shall be given hereafter are in the context of closed-loop stored-value instruments (such as gift cards), the techniques described herein may be applied to other stored-value instruments or direct transfer of value.

ATMs are networked to banking institutions either through direct wired connections, wireless connections, the Internet, or the PSTN (Public Switched Telephone Network), or through other connections known in the art. Other ATMs may not be directly networked to a banking institution and may instead be a terminal that processes credit or debit card transactions.

The ATMs which are connected to the Internet or other wired or wireless network may be upgraded, in manners known in the art, with software or firmware implementing the processes and methods described herein. ATMs which are not capable of being upgraded over a network connection can be have their software or firmware upgraded using a manual installation method at the physical location of the ATM in a typical manner known in the art.

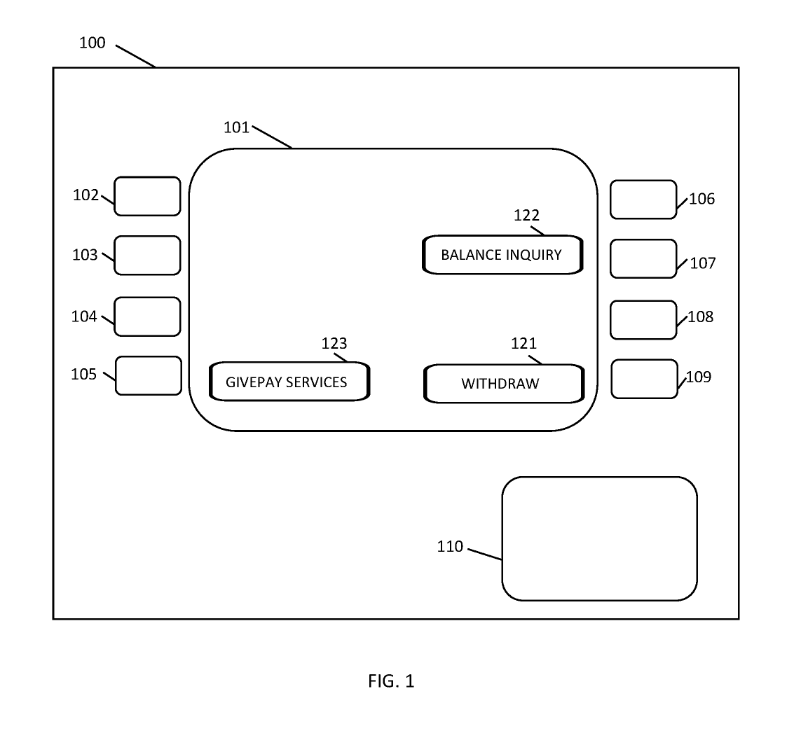

FIG. 1 depicts a typical ATM 100 having a visual display screen 101. ATMs typically have a basic GUI with a configuration of 8 physical push buttons 102-109 around the visual display screen 101 with a typical numeric keypad 110 having some configuration of numbers “0-9”, “YES”, “NO”, “BACK”, “DELETE”, “ENTER”, and/or “CANCEL.” It should be appreciated that other ATM embodiments may have similar GUIs that incorporate and use a touch screen for user input rather than physical push buttons or varying amounts of physical push buttons. Further, other ATM embodiments use a combination of physical push buttons and one or more touch screens to allow user input.

The ATM user can typically use the ATM to withdraw, deposit, or check their bank account balances using the visual display and configuration of physical buttons and numerical keypad.

FIG. 1 further depicts a typical ATM 100 wherein the visual display screen 101 renders various menu options which are associated or correlated with one or more physical push buttons, touch screen responsive areas, or the typical numeric keypad, such menu options include, but are not limited to “withdraw” 121, “balance inquiry” 122, and novel to the present invention “GivePay Services” 123, which are described in further detail herein. It should be appreciated that the names of the menu options may vary or be modified as necessary or desired by the owner and/or operator of the ATM. The present invention contemplates creating a value-added service for the owners and operators of ATMs to generate additional usage and interactions with the ATM. In an ATM upgraded to implement the processes and methods described herein, the ATM will display an idle screen or welcome screen offering electronic stored-value purchases and transmission of the same via the API. The first embodiment of the idle or welcome screen displays various categories of stored-value instruments and prompts the user to learn more or otherwise begin a typical ATM transaction. The upgraded ATM idle or welcome screen may be a static image, multiple images being displayed in a rotation, and/or, subject to hardware capabilities, video tracks (which may include audio and/or music tracks). The user of the ATM can select, purchase and transmit the stored-value instrument as part of his or her typical ATM usage (i.e. after checking their account balance or withdrawing funds) or simply use the upgraded ATM to conveniently purchase and transmit the stored-value instrument. This novel process and method for purchasing and transmitting electronic stored-value instruments via the ATM GUI allows user the convenience of being able to directly transmit the electronic stored-value instrument to the intended recipient's phone number (via SMS, MMS or other messaging service) or email address rather than having to physically exchange a physical stored-value instrument or mail the physical stored-value instrument. Electronic delivery of the stored-value instrument also negates the potential for the purchaser or the recipient losing the physical stored-value instrument, which typically results in a complete loss of the associated stored-value.

Other alternative embodiments of the ATM idle or welcome screen can be implemented using a sponsored or paid advertising methodology to display the sponsoring entities' name, logo, branding, or other advertisement. In any embodiment, it should be appreciated that the ATM idle or welcome screen may be updated dynamically by the ATM operator through the ATM GUI or through a web portal, FTP, or similar interface, which then executes the appropriate processes to transmit and install the idle or welcome screens or videos.

The typical ATM GUI can be updated to include a selection button on one or more transaction menus to invite the user to purchase and transmit an electronic stored-value instrument at any stage during their usage of the ATM, e.g. before, during, or after their typical banking transaction. The selection of the button to purchase of the stored-value instrument may cancel the user's current typical ATM transaction or invoke a function to begin the store-value instrument purchase only after the user completes his or her typical ATM transaction. Of course, the user may also begin the selection and purchase of the electronic stored-value instrument without first conducting a banking transaction.

It should be appreciated that the inclusion of the value-added services to an ATM may also include “wireless top-up,” e.g. pre-paid cellular phone minutes or data plans, donations, gift card exchanges (e.g., exchanging a stored-value instrument for a first retailer with a stored-value instrument for a second retailer), general purpose reloadable cards, direct value transfer and/or bill pay options.

It should be appreciated that small and medium-sized merchants may use the provided API to create, offer, and sell private label gift cards or other stored-value instruments through the ATM GUI allowing these merchants access to a wider consumer audience than was available to them before.

Additional and further embodiments include the use of schemes to allow the ATM owner/operator to set various values and conditions with an API that controls one or more ATMs. ATMs may be grouped by various distinguishing characteristics such as geographic location, recorded user traffic, nearby amenities, or other such characteristics. The grouping of ATMs allows the owner/operator to perform maintenance on a plurality of ATMs with a single action using a scheme. Such schemes include viewing, updating, and/or modifying the offered stored-value instruments, values, brands, fees, wireless carriers, fulfillment priorities, greetings, messages, GUI components, and the like as discussed herein. The ATM owner/operator may also use the API to view, update, or modify the fulfillment priority by assigning a higher or lower value to a particular stored-value instrument provider based on various characteristics, such as fees, costs, availability, or the like.

Additional and further embodiments include the capabilities to allow ATM users to exchange physical gift cards or other stored-value instruments for cash or another stored-value instrument offered through the ATM.

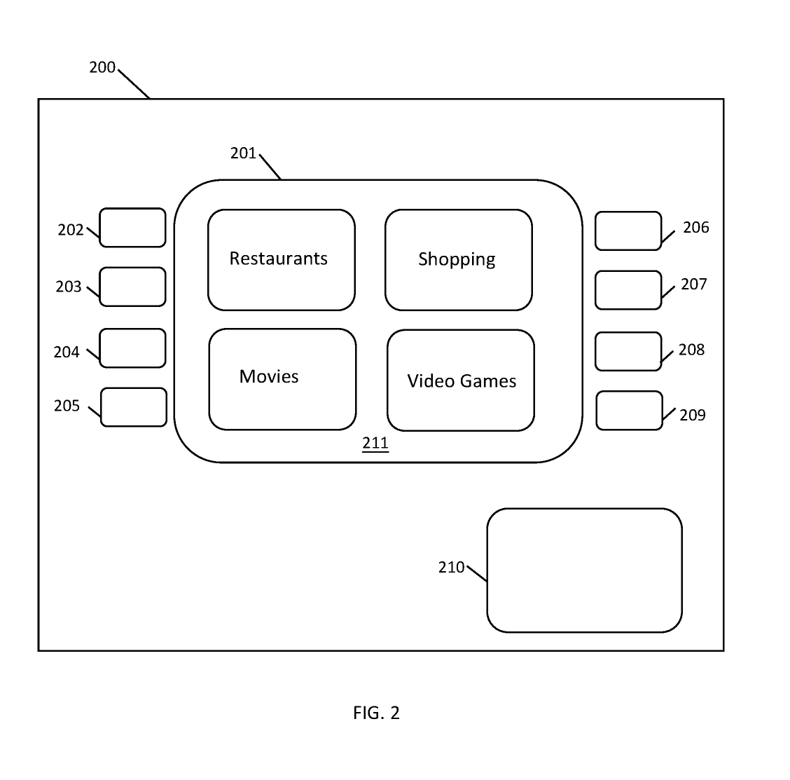

FIG. 2 depicts an exemplary ATM 200, similar to FIG. 1, having a visual display screen 201 with physical push buttons 202-209 and numeric keypad 210. An exemplary embodiment describes the process for purchasing and transmitting an electronic stored-value instrument via the aforementioned upgraded ATM GUI. The process begins with the user of the ATM being offered the option to purchase an electronic stored-value instrument using funds from their active bank account (via the insertion of their debit card and entry of their PIN) or credit card. The ATM GUI includes an option to view a stored-value instrument collage 211 on the visual display screen 201, which provides the user with one or more categories to choose from. The user can then select a particular category pressing the associated input button on the ATM, which will then send a request to the API to retrieve and then render on the ATM screen the various options for sub-categories of electronic stored-value instruments It should be appreciated that there could be many categories and sub-categories of electronic stored-value instruments, including, but not limited to, movie tickets, video rentals, restaurants, fast food, grocery stores, on-line shopping (e.g. an ecommerce site or convenience stores, retail brick-and-mortar stores, digital music services, on-line gaming, GPR Open loop cards (e.g. network branded pre-paid cards). It should be appreciated that such stored-value accounts can be reloaded or receive additional stored-value by using the disclosed invention to use the ATM that enables selecting the stored-value instrument type on the ATM GUI and/or inserting a physical stored-value instrument card to obtain the stored-value account number and then using the disclosed process to enable a user to select the amount of value to add or “reload” to the account. The user can then scroll through the options by using a touchscreen interface or with the associated input buttons to view the next grouping of categories. It should be appreciated that the categories presented may have sub-categories associated with them and that if the category with a sub-category is selected by the user that the ATM GUI will perform the same steps to send a request to the API to retrieve or use previously retrieved data from the API and then render on the ATM screen the various sub-categories of the main category selected by the user. Further, sub-categories may have their own sub-sub-categories to further define the particular selection of electronic stored-value instruments offered. When the user selects the desired category (and any sub-categories) the ATM GUI will render and display the offered brands within the category and/or sub-categories. When the user selects the desired brand, the ATM GUI will render and display the offered electronic stored-value instruments (which may vary by image, greeting, color, denomination, or other visual characteristic).

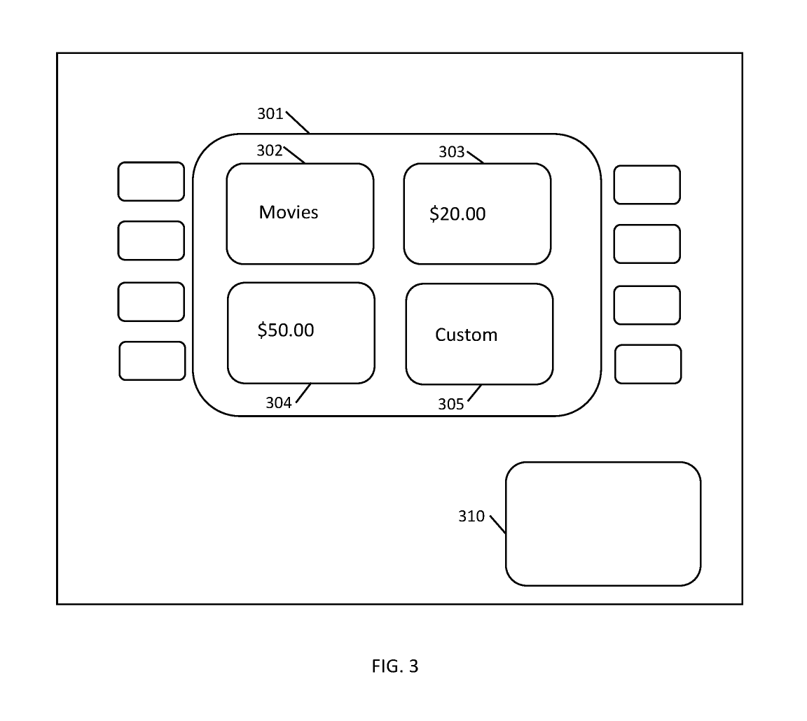

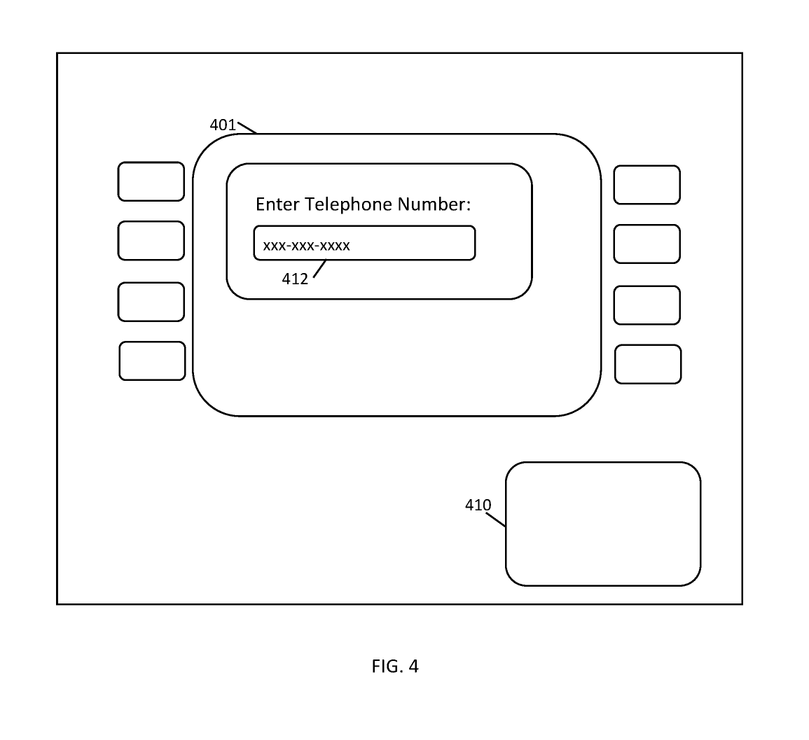

FIG. 3 depicts the ATM visual display screen 301 rendering and displaying offered denominations available for the category 302 of electronic stored-value instrument in pre-assigned amounts 303-304 (e.g. $10, $20, $50, $100, etc.) and/or render and display a GUI to allow a customized denomination amount 305 to be entered by the user for the selected electronic stored-value instrument. At this step, the user may also input a customized denomination 305 amount using the ATM numeric keypad 310. Referring to FIG. 4, the ATM visual display screen 401 will then render and display an ATM GUI or prompt the user to use the numeric keypad 410 to allow the user to enter a telephone number 412 of the recipient of the electronic stored-value instrument and, optionally, the telephone number of the giver, which will typically be the user of the ATM, but not necessarily. It should be appreciated that the same or similar step and ATM GUI can be used to receive input of either or both the purchaser and/or the intended recipient's telephone numbers. After the ATM GUI receives the aforementioned inputs from the ATM user for the selected electronic stored-value instrument, denomination, and telephone numbers of the user and the recipient, then the ATM GUI will send an order command to the API. The API will then return to the ATM GUI the order details with a grand total, including any processing fees or other fees or taxes as may be included or required in the jurisdiction or by the ATM owner/operator. The ATM GUI will ask the user to confirm the final purchase, and upon confirmation by the user, then ATM GUI will then transmit the final order and confirmation to the API, which then relays the final order and confirmation to a payment processing gateway and/or switch for authentication and confirmation of a completed payment transaction. Upon successful authentication of the transaction, the payment processing gateway will transmit to the API a payment complete acknowledgement. The API then relays the acknowledgement to the ATM GUI, which then renders and displays the confirmation of the completed order to the user. Contemporaneously with the display of the confirmation to the user, the API communicates to the electronic stored-value instrument servicer API the details of the transaction to purchase the stored-value instrument electronically. The stored-value instrument servicer API then processes the transactions and prepares and transmits to the API a redemption URL code, claim, bar code, OR code, pin, or the like that the API then transmits via SMS (or other messaging service and/or e-mail) to the recipient of the electronic stored-value instrument.

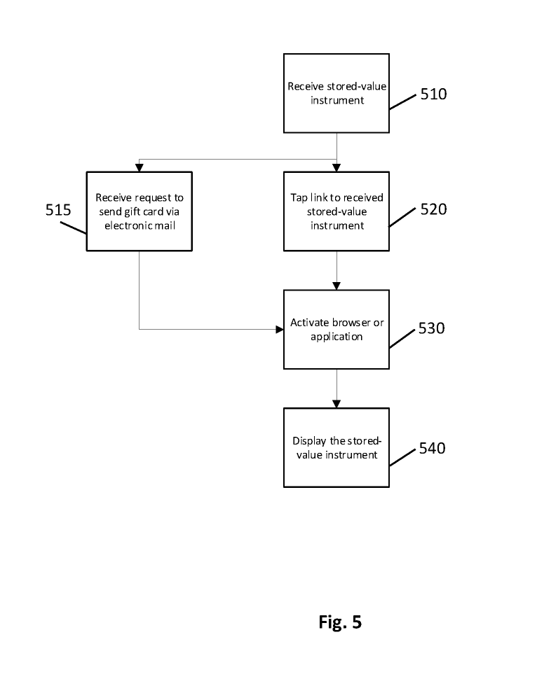

FIG. 5 depicts the process of redeeming an electronic stored-value instrument as described herein. Step 510 the recipient of the electronic stored-value instrument will thereafter receive an SMS (and/or other message or e-mail) containing the URL and/or other data, which is a link to the electronic stored-value instrument. Step 515 presents an alternative route to Step 520 wherein the recipient of the electronic stored-value instrument is presented with an option to receive the electronic stored-value instrument via an electronic mail. Alternatively, and preferably, Step 520 when the recipient selects the URL in the SMS (or other messaging service or e-mail), then step 530 the recipient's phone or computer browser will then be activated by the selection of the URL. The browser will then render and display a webpage containing a text and/or graphical depiction of the gift card, which the recipient can interact with via selection or add the funds to an account 540. For example, as shown in FIG. 5, the recipient may receive an SMS containing a URL 510. When the user taps on the URL 520 it activates the recipient's cellular phone Internet browser to a webpage that renders a graphical depiction of the electronic stored-value instrument including the denomination of the electronic stored-value instrument 530. The recipient can view a serial number, PIN, bar code, OR code, or other similar identifier, or if the recipient has the appropriate associated application installed then the user can be taken directly to the application to have the stored value instrument associated with the application, for example a digital gift card could be associated with a 1^{st} party digital wallet such as a Give Pay Wallet, Apple Wallet, Google Pay or Android Pay™, or other third-party digital wallets for storing stored-value instruments or currencies 540.

In an embodiment where the ATM user purchases an electronic stored-value instrument for cellular phone minutes or data, or alternatively, directly purchases cellular phone minutes or data for the account associated with recipient's cellular phone number, then once the transaction is confirmed via the payment processing gateway the recipient is sent a notification (via SMS, MMS, or other messaging service or e-mail) that a payment has been applied to the recipient's account. The recipient's cellular phone account is contemporaneously credited with the purchased amount of value in the ATM user's transaction.

It should be appreciated that there may be a convenience fee that varies based on items purchased and that the owner and/or operator of the ATM may modify the service fee or convenience fee value(s) to cover the transaction and opportunity costs associated with the use of the ATM when a user purchases a stored-value instrument using the processes and methods described herein. Additionally, it should also be appreciated that the recipient of the electronic stored-value instrument may be responsible for any SMS, MMS, or other messaging service fees or costs and/or data rates.)

It should be appreciated that the ATM user when purchasing the stored-value instrument may also be presented with the option to include a greeting via a pre-written message (e.g., “Happy Birthday”, “Congratulations!”, “Happy Holidays”, or the like), a static picture (e.g., balloons, cake, wrapped presents, teddy bear, or the like), an animated picture (e.g., a dancing cartoon bear, twinkling stars, a snowing landscape scene, or the like), and/or a video (e.g., a link to a YouTube® video, or the like). Additionally where the ATM supports a touch screen or alphanumeric keyboard, it should be appreciated that the ATM user may be presented with an option from the ATM GUI to input a personalized message or greeting when selecting greetings. It should be further appreciated that the aforementioned options may be presented as a URL to be interacted with by the recipient, which would then open the recipient's browser or appropriate associated application, or it may be inserted directly into the message being sent to the recipient.

It should be further appreciated that the processes and methods described herein may require the ATM user to satisfy a prompt from the ATM GUI certifying that the user has the recipient's consent to send messages to the recipient. This authorization and consent to receive messages associated with the electronic stored-value instrument transaction may be required by some jurisdictions due to consumer protection laws, minor children laws, or other laws or regulations.

Other and further embodiments include the option to enable the ATM user to donate to charitable organizations through the ATM GUI. Additionally, the ATM GUI allows the ATM user to pay utility bills or other payment forms via the ATM GUI.

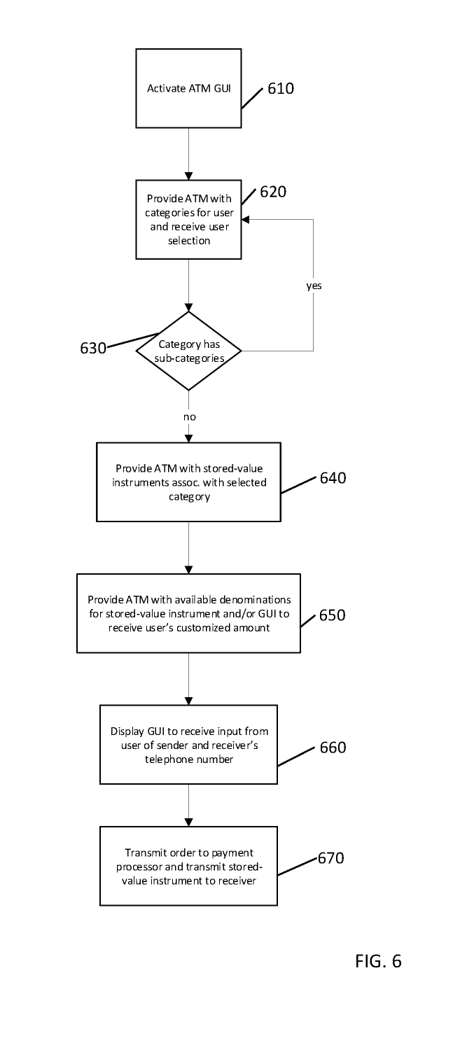

FIG. 6 depicts an exemplary process for purchasing an electronic stored-value instrument. Step 610 is the activation of the ATM GUI, which may be a visual display depicting an option to view and/or purchase electronic stored-value instruments or wireless minutes or data credits. The ATM GUI may include an alternative visual display depicting various offerings to observers of the ATM visual display. Alternatively, the ATM GUI may need to be activated by a user of the ATM through the interaction of a touchscreen or pressing of one or more of the physical buttons. Step 620 the ATM visual display screen depicts one or more specific categories of stored-value instruments, as described herein. Step 630 after receiving a user input for the specific category, the ATM GUI will process the user input and if the selected specific category has one or more sub-categories, the ATM GUI will refresh the visual display screen and depict one or more sub-categories associated with the selected specific category. This step will repeat until a level of category is reached without further sub-categories, then the process will continue to Step 640. Step 640 after receiving a user input for the specific brand, the AMT GUI will process the user input and depict one or more stored-value instruments associated with the selected brand. The stored-value instruments may be varied by graphical or categorical depictions, such as holidays, events, or other such variables. Step 650, after receiving a user input for the specific stored-value instrument, the ATM GUI will process the user input and depict one or more denominations for the stored-value instruments associated selected brand. Alternatively, the ATM GUI may receive a user input for a customized amount entered by the ATM user for the denomination amount. Step 650 after receiving the inputted amount, whether pre-determined or customized by the ATM user, the ATM GUI will display a prompt to receive input from the ATM user for a telephone for one or more of the sender and/or receiver of the electronic stored-value instrument. Step 660 after receiving the inputted telephone number or numbers, the ATM GUI transfer the order for the electronic stored-value instrument to a payment processor, which validated the order and then causes to transmit the electronic stored-value instrument to the receiver step 670.

In general, the various exemplary embodiments may be implemented in hardware or special purpose circuits, software, logic, or any combination thereof. For example, some aspects may be implemented in hardware, while other aspects may be implemented in firmware or software which may be executed by a controller, microprocessor, or other computing device, although the invention is not limited thereto. While various aspects of the exemplary embodiments of this of this invention may be illustrated and described as block diagrams, flow charts, or using some other pictorial representation, it is well understood that these blocks, apparatus, systems, techniques, or methods described herein may be implemented in, as non-limiting examples, hardware, software, firmware, special purpose circuits or logic, general purpose hardware or controller, or other computing devices, or some combination thereof.

It should be appreciated that at least some aspects of the exemplary embodiments of the inventions may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, baseband circuitry and radio frequency circuitry that are configurable so as to operate in accordance with the exemplary embodiments of the invention.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

Furthermore, some of the features of the various non-limiting and exemplary embodiments of this invention may be used to advantage without the corresponding use of other features. As such, the foregoing description should be considered as merely illustrative of the principles, teachings, and exemplary embodiments of this invention, and not in limitation thereof.

1. An automated teller machine system comprising:
one or more displays for rendering and displaying to a user a graphical user interface;
one or more input devices for receiving a user input;
one or more communication devices for enabling network access by the automated teller machine system to one or more remote servers;
one or more hardware processors configured to perform the steps of:
displaying a graphical user interface providing a graphical depiction of a plurality of categories for stored-value instruments;
receiving a selection from a user of a category of the plurality of categories for stored-value instruments;
retrieving from the one or more remote servers a plurality of brands for stored-value instruments for the selected category;
displaying a graphical user interface providing a graphical depiction of a plurality of brands for stored-value instruments for the selected category;
receiving a selection from the user of a brand of the plurality of brands for stored-value instruments;
retrieving from the one or more remote servers a plurality of stored-value instruments for the selected brand;
displaying a graphical user interface providing a graphical depiction of a plurality of denominations for the stored-value instruments for the selected brand;
receiving a selection from the user of the denomination for the stored-value instrument;
displaying a graphical user interface providing a graphical depiction of the selections made by the user and a total amount of the stored-value instrument to be purchased;
transmitting via the one or more communications devices a payment authorization request to the one or more remote servers;
receiving via the one or more communications devices an authorization acknowledgement; and
displaying a graphical user interface providing a graphical depiction of the authorization acknowledgement.

2. The automated teller machine system of claim 1, wherein the input device comprises a numeric keypad.

3. The automated teller machine system of claim 1, wherein the input device comprises a touch screen display.

4. The automated teller machine system of claim 1, wherein the one or more hardware processors further comprises the step of:
displaying a graphical user interface providing a graphical depiction of one or more digital greetings;
receiving a selection from the user of one of the digital greetings; and
wherein the displaying a graphical user interface providing a graphical depiction of the selections made by the user and a total amount of the stored-value instrument to be purchased further comprises the selection from the user of the one of the digital greetings.

5. A method for enabling the purchase of wireless telecom provider credits comprising the steps of:
receiving a telephone number from a user input;
retrieving an identity of a wireless telecom provider based in-part on the telephone number;
retrieving a plurality of credit products associated with the wireless telecom provider;
ranking the plurality of credit products associated with the wireless telecom provider based on a priority value;
selecting the credit product associated with the wireless telecom provider having the highest priority value;
providing a graphical depiction of a plurality of denominations for the selected credit product associated with the wireless telecom provider having the highest priority value;
receiving a user input selecting a denomination of the plurality of denominations for the selected credit product associated with the wireless telecom provider having the highest priority value;
transmitting an authorization request containing the received user input of the denomination to a remote server;
receiving an authorization response from the remote server; and
providing a graphical depiction of the authorization response.

6. The method of claim 5, wherein the wireless telecom provider credits are wireless minutes.

7. The method of claim 5, wherein the wireless telecom provider credits are wireless data credits.

8. A method for enabling charitable donations using an automated teller machine, comprising:
providing a graphical depiction of a plurality of charitable organizations with suggested donation amounts;
providing a graphical depiction of a plurality of charitable organizations with a direct account payment;
retrieving a plurality of charitable organizations based on the identity of the account holder;
ranking the plurality of charitable organizations associated with the account holder based on a priority value;
selecting one of the plurality of charitable organizations associated with the account holder having the highest priority value;
providing a graphical depiction of a plurality of denominations for the selected charitable organization associated with the account holder having the highest priority value;
receiving a user input from the account holder selecting a denomination of the plurality of denominations for the charitable organization associated with the account holder having the highest priority value;
transmitting an authorization request containing the received user input of the denomination to a remote server;
receiving an authorization response from the remote server; and
providing a graphical depiction of the authorization response.
